(19) United States
(12) Patent Application Publication
(10) Pub. No.: US 2004/0130064 A1
(43) Pub. Date: Jul. 8, 2004

(54) Method for manufacturing multi-piece golf ball and a mold

(76) Inventors: Norikazu Ninomiya, Osaka-shi (JP); Kenji Onoda, Kashihara-shi (JP); Masao Ogawa, Osaka-shi (JP); Yuri Naka, Katano-shi (JP)

Correspondence Address: STITES & HARBISON PLLC, 1199 NORTH FAIRFAX STREET, SUITE 900, ALEXANDRIA, VA, 22314, US

(21) Appl. No.: 10/337,659

(22) Filed: Jan. 8, 2003

(51) Int. Cl. B29C 43/18; B29C 71/02

(52) U.S. Cl. 264/236; 264/250; 425/408

(57) ABSTRACT

A method for manufacturing a multi-piece golf ball provided with a core material and an outer layer molded on the surface of the core material, which comprises the steps of: i) simultaneously molding a pair of semispherical outer-layer-pieces that are composed of a composition containing semi-vulcanized rubber; ii) inserting a separately molded core material between the pair of outer-layer-pieces, and bringing the mouths of the pair of outer-layer-pieces into contact; and iii) vulcanizing the rubber contained in the outer-layer-pieces by press molding to obtain an outer layer that comprises a rubber composition on the surface of the core material.

### BACKGROUND OF THE INVENTION

1. Field of the Invention

The present invention relates to a mold for forming an outer layer of a multi-piece golf ball and a manufacturing method thereof.

2. Description of Related Art

In manufacturing a multi-piece golf ball, when a layer is formed, it is necessary to align the center thereof with the center of a core material that is placed inside the layer. Therefore, the objective layer has hitherto been formed in the following manner.

First of all, using a plurality of removable holding pins, a core material that has been molded beforehand is held in the position in a cavity where the core material becomes concentric to the cavity of a mold that has a spherical cavity therein. Then, the mold is closed, a fluid material for forming the objective layer is injected into the mold, and the fluid material is hardened. When the objective layer is not completely hardened but solidified to such a degree that the core material that has been subjected to the centering does not move, the removable holding pins are pulled out.

However, in this method, the mold becomes complicated in order to allow the removable holding pins to be pulled out. Furthermore, it is difficult to control the timing for pulling out the removable holding pins.

Japanese Unexamined Patent Publication No. 1999-70188 discloses a method for manufacturing an intermediate for a golf ball that is composed of a spherical core and an outer layer, which comprises the steps of forming semispherical outer-layer-half-split bodies by making an unvulcanized rubber material to be semi-vulcanized rubber or vulcanized rubber, and vulcanizing and pressing a core that is made of unvulcanized rubber while holding it between the half-split bodies.

However, in the method taught by Japanese Unexamined Patent Publication No. 1999-70188, when the outer-layer-half-split bodies are made of a semi-vulcanized rubber material, it is difficult to accurately mold the core material and outer layer into desired shapes, because the core is in an unvulcanized state and exhibits plasticity when even a slight force is applied thereto.

Furthermore, when the outer-layer-half-split bodies are made of vulcanized rubber, in respect to the obtained golf ball, adhesiveness between the outer-layer-half-split bodies and, accordingly, the strength of the outer layer are not satisfactory for actual usage.

### BRIEF SUMMARY OF THE INVENTION

With the foregoing situation in view, the present invention aims at providing a method for manufacturing a multi-piece golf ball wherein the centering with the core material can be readily performed, and a mold for use in the same.

In order to achieve the above objects, the present inventors conducted extensive research and acquired the following findings.

i) When an outer layer is formed on the surface of a core material by simultaneously forming a pair of semispherical outer-layer-pieces that comprises a semi-vulcanized rubber composition, holding a separately formed core material between the pair of outer-layer-pieces, and setting the outer-layer-pieces by vulcanization, it is possible to obtain the outer layer while readily and accurately conducting centering between the core material and the outer layer.

ii) Furthermore, because the vulcanization is conducted after putting the circular end faces of the pair of outer-layer-pieces together in a semi-vulcanized condition, the strength of the attached portion of the outer layer is the same or substantially the same as that of the other part of the outer layer, and therefore it is possible to mold an outer layer having a strength satisfactory for practical use.

iii) When the outer layer is formed, using an upper part of the mold and a lower part of the mold each having a semispherical concave portion, and a middle part of the mold provided with a plate-like separator having semispherical convex portions on both surfaces, by simultaneously forming a pair of semispherical outer-layer-pieces, removing the middle part of the mold while keeping the outer-layer-pieces attached to the corresponding upper and lower parts of the mold, inserting the separately formed core material between the outer-layer-pieces in its place, and setting the outer-layer-pieces by conducting vulcanization while holding the core material therebetween, formation of the outer layer becomes remarkably simplified compared to the case where a pair of semispherical outer-layer-pieces are formed using separate molds.

The present invention is completed based on the above findings and provides a method for manufacturing multi-piece golf balls and molds for use thereof as described below.

1. A mold for forming an outer layer of a multi-piece golf ball comprising upper and lower parts of the mold each having one, two or more semispherical concave portions, and a middle part of the mold arranged therebetween when necessary,

the middle part of the mold comprising semispherical convex portions having a radius smaller than that of the mold cavity formed by concave portions of the upper and lower parts of the mold, and a plate-like separator having a size that can cover the concave portions of the upper and lower parts of the mold,

the semispherical convex portions being disposed on both surfaces of the separator in positions corresponding to the concave portions of the upper and lower parts of the mold.

2. The mold for forming an outer layer of a multi-piece golf ball according to Item 1, wherein the upper and lower parts of the mold comprise one, two or more small concave portions of the same depth on the surfaces of the semispherical concave portions.

3. The mold for forming an outer layer of a multi-piece golf ball according to Item 1, wherein the surfaces of the concave portions of the upper and lower parts of the mold have a greater mold-releasing resistance than the surface of the middle part of the mold.

4. A method for manufacturing a multi-piece golf ball that is provided with a core material and an outer layer formed on the surface of the core material, the method comprising :

i) simultaneously molding a pair of semispherical outer-layer-pieces comprising a composition that contains semi-vulcanized rubber;

ii) inserting a separately molded core material between the pair of outer-layer-pieces, and bringing the end faces of the openings of the pair of outer-layer-pieces into contact; and

iii) molding an outer layer comprises a rubber composition on the surface of the core material by vulcanizing the rubber contained in the outer-layer-pieces.

5. The method according to Item 4, wherein the condition of the semi-vulcanized rubber, when expressed as torque measured by a curastmeter, is such that the torque becomes the sum of the torque immediately after the start of vulcanization and 20 to 70% of the difference between the torque immediately after the start of vulcanization and that after the completion of vulcanization.

6. The method according to Item 4, wherein the outer layer serves as the intermediate layer of a three-piece golf ball and the core material serves as the core of the three-piece golf ball.

7. The method according to Item 4, wherein the outer layer is the outer core layer of a three-piece golf ball and the core material is the inner core of the three-piece golf ball.

8. A method for manufacturing a multi-piece golf ball that is provided with a core material and an outer layer formed on the surface of the core material, the method comprising :

i) using a mold provided with upper and lower parts of the mold each having one, two or more semispherical concave portions, and a middle part of the mold arranged therebetween when necessary, wherein the middle part of the mold comprises semispherical convex portions having a radius smaller than that of the mold cavity formed by concave portions of the upper and lower parts of the mold, and a plate-like separator having a size that can cover the concave portions of the upper and lower parts of the mold, wherein the semispherical convex portions are disposed on both surfaces of the separator in positions corresponding to the concave portions of the upper and lower parts of the mold;

simultaneously molding a pair of semispherical outer-layer-pieces comprising a composition that contains semi-vulcanized rubber, by vulcanizing the rubber while pressing the rubber composition between the concave portions of the upper and lower parts of the mold and the corresponding convex portions of the middle part of the mold;

ii) removing the middle part of the mold while keeping the outer-layer-pieces attached to the corresponding upper and lower parts of the mold, inserting a separately molded core material between the outer-layer-pieces that are attached to the upper and lower parts of the mold, and bringing the end faces of the openings of the pair of outer-layer-pieces into contact; and

iii) pressing the outer-layer-pieces and the core material between the upper and lower parts of the mold, vulcanizing the rubber that is contained in the outer-layer-pieces, and thereby molding an outer layer that comprises a rubber composition on the surface of the core material.

9. The method according to Item 8, wherein the upper and lower parts of the mold have one, two or more small concave portions of the same depth on the surfaces of the semispherical concave portions thereof.

10. The method according to Item 8, wherein the surfaces of the concave portions of the upper and lower parts of the mold have a greater mold-releasing resistance than the surface of the middle part of the mold.

11. The method according to Item 8, wherein the condition of the semi-vulcanized rubber, when expressed as torque measured by a curastmeter, is such that the torque becomes the sum of the torque immediately after the start of vulcanization and 20 to 70% of the difference between the torque immediately after the start of vulcanization and that after the completion of vulcanization.

12. The method according to Item 8, wherein the outer layer serves as the intermediate layer of a three-piece golf ball and the core material serves as the core of the three-piece golf ball.

13. The method according to Item 8, wherein the outer layer serves as the outer core layer of a three-piece golf ball and the core material serves as the inner core of the three-piece golf ball.

According to the method for manufacturing a multi-piece golf ball of the present invention, it is possible to form an outer layer while accurately and readily adjusting its center with the center of the core material. Furthermore, when the mold of the present invention is used, it is possible to mold an outer layer while accurately adjusting its center with the center of the core material by a remarkably simpler operation compared to the case where a pair of outer-layer-pieces are separately molded. The resulting ball exhibits extremely little eccentricity.

Furthermore, because the outer-layer-pieces are hardened while putting the circular end faces of the pair of outer-layer-pieces together in a semi-vulcanized condition, the strength of the attached portion of the outer layer is the same or substantially the same as that of the other part of the outer layer, and therefore it is possible to obtain a golf ball having a strength satisfactory for practical use without having cracks on the attached portion or breakage of the ball while using.

When ribs exist on the surface of the core material so as to separate the outer layer into a plurality of portions, it is impossible to obtain the outer layer by injection molding. However, it is possible to form even an outer layer that is made of a material not suitable for injection molding onto such a core material surface by press molding.

### BRIEF DESCRIPTION OF THE DRAWINGS

FIG. 1 is a cross-sectional view schematically showing one example of the mold of the present invention.

FIG. 2 is a diagram explaining the steps of manufacturing an intermediate layer of a three-piece golf ball according to the method of the present invention.

### DETAILED DESCRIPTION OF THE INVENTION

Hereunder, the present invention is explained in detail.

### (I) Mold

Basic Structure

A mold for forming an outer layer of a multi-piece golf ball of the present invention comprises upper and lower parts, each having one, two or more semispherical concave portions, and a middle part of the mold arranged therebetween when necessary. The middle part of the mold comprises semispherical convex portions having a radius smaller than that of the spherical mold cavity formed by the concave portions of the upper and lower parts of the mold, and a plate-like separator having a size that can cover the concave portions of the upper and lower parts of the mold. The semispherical convex portions of the middle part of the mold are arranged on both surfaces of the separator in the positions corresponding to the concave portions of the upper and lower parts of the mold.

Upper and Lower Parts of the Mold

The radius of the semispherical concave portions of the upper and lower parts of the mold is equal to ½ of the outer diameter of either the golf ball or the intermediate product for the golf ball obtained by forming the outer layer with this mold.

The upper and lower parts of the mold can comprise one, two or more small concave portions of the same depth on the surfaces of the semispherical concave portions of the upper and lower parts of the mold. Examples of the shapes of the small concave portion include a cone shape, a frustum, a groove having a triangular profile in its vertical cross-section, a groove having a trapezoidal profile in its vertical cross-section, etc. By employing the mold provided with such a small concave portion or portions, it is possible to form, on the spherical body, an outer layer comprising a protrusion or protrusions, a rib or ribs, or the like having the shape same as that of the small concave portions. As described later, examples of such outer layers include an intermediate layer or an outer core having a protrusion/protrusions, rib/ribs, etc.

The surfaces of the concave portions of the upper and lower parts of the mold (when they have small concave portions, the surfaces of the concave portions and the small concave portions) can be smooth or rough having fine irregularities; however, a rough surface is preferable.

In the case where surfaces are rough with a roughness in the above-described range, if an outer layer of a golf ball is formed using this mold and following the method of the present invention, it becomes easier to open the upper and lower parts of the mold while keeping the semi-vulcanized outer-layer-pieces attached to the corresponding concave portions. Since the outer surface of the resulting outer layer becomes rough, it is also possible to enhance the adhesiveness between the outer layer and a layer molded further outside the outer layer.

Each of the upper and lower parts of the mold can further comprise a secondary concave portion around the semispherical concave portion on the surface where the semispherical concave portion is formed. The secondary concave portions serve to hold any excess of the material for the outer-layer-pieces that overflows from the mold cavity when the upper and lower parts of the mold are closed while holding the core material between the upper and lower parts of the mold. The secondary concave portion can be designed such that a plurality thereof are arranged in a spotted manner, or such that a ring-shape thereof is arranged around the semispherical concave portion. However, it is preferable that the secondary concave portion be arranged around the semispherical concave portion in the shape of a ring.

Middle Part of the Mold

The radius of the convex portion of the middle part of the mold is the same as the radius of the golf ball or the core material of the intermediate product for the golf ball manufactured using this mold or smaller by about 0.1 to 0.4 mm. Here, the radius of the core material indicates the radius of the spherical body excluding protrusions, ribs, or the like, if protrusions, ribs, etc., exist on the surface of the core material.

Furthermore, it is preferable that the surface portion of the middle part of the mold provided with the convex portions and the separator be a mold-releasing layer that comprises at least one member selected from the group consisting of fluorine-based resins and silicone-based resins. Alternatively, the middle part of the mold may have a mold-releasing agent that comprises at least one member selected from the group consisting of fluorine-based resins and silicone-based resins on its surface. Thereby, when an outer layer is molded using this mold, it is possible to readily separate the outer-layer-pieces from the middle part of the mold while keeping them attached to the upper and lower parts of the mold.

As described above, by improving the mold-release property of the surface of the middle part of the mold and/or forming the surfaces of the upper and lower parts of the mold as rough surfaces, it is preferable that the surfaces of the concave portions of the upper and lower parts of the mold have a greater mold-releasing resistance, i.e., lower releasability, than the surface of the middle part of the mold.

The plate-like separator and the convex portions of the middle part of the mold, so long as they are integrally arranged, can be made of a material different from each other, or they can be made of the same material.

### (II) Method for Manufacturing a Multi-Piece Golf Ball

Basic Structure

The method for manufacturing a multi-piece golf ball of the present invention is a method for manufacturing a multi-piece golf ball that is provided with a core material and an outer layer comprising a rubber composition formed onto the surface of the core material, wherein the method comprises the steps of:

i) simultaneously molding a pair of semispherical outer-layer-pieces comprises a composition that contains semi-vulcanized rubber;

ii) inserting a separately molded core material between the pair of outer-layer-pieces, and bringing the end surfaces of the openings of the pair of outer-layer-pieces into contact; and

iii) forming an outer layer comprising a rubber composition on the surface of the core material by vulcanizing the rubber that is contained in the outer-layer-pieces.

In the present invention, the “core material” may be a core (a core formed as an unit that cannot be divided into an inner core and an outer core), an inner core, or a member comprising a core and one or more intermediate layers formed around the core. The “outer layer” may be an outer core or an intermediate layer. Therefore, the method of the present invention includes the cases where the core material is a core and the outer layer is an intermediate layer; the core material is an inner core and the intermediate layer is an outer core; and the core material is a member comprising a core and one or more intermediate layers around the core and the outer layer is an intermediate layer.

The shape of the core material is not limited and can be spherical, a shape having a spherical body and protrusions, ribs, or the like on the surface of the spherical body, etc.

Materials for Each Layer

1) Core or Inner Core

As the materials for the core and the inner core, known rubber compositions for use in a core and an inner core of a multi-piece solid golf ball, respectively, can be used.

As the basic rubber, both natural rubber and synthetic rubber can be used. Among these, high-cis polybutadiene rubber that contains 40% or more and particularly 80% or more of cis-1,4-bond is preferable. Natural rubber, polyisoprene rubber, styrene-butadiene-rubber, ethylene-propylene-diene rubber (EPDM), and the like may be added to the high-cis polybutadiene.

The rubber composition can additionally contain a cross-linking agent, a metal salt/salts of unsaturated carboxylic acid/acids serving as a cocross-linking agent, a filler, an antioxidant, a peptizer, etc.

Examples of the cross-linking agents include dicumyl peroxide, t-butyl peroxide and like organic peroxides. Particularly, dicumyl peroxide is preferable. The preferable proportion of the cross-linking agent is, based on 100 parts by weight of basic rubber, generally about 0.5 to 3 parts by weight and particularly about 0.7 to 2.2 parts by weight. If the proportion thereof falls into the above range, the resulting golf ball can attain a sufficient resilience property, accordingly achieving a sufficiently long flight distance as well as a sufficiently soft feel.

Examples of the metal salts of unsaturated carboxylic acids that serve as a cocross-linking agent include univalent or bivalent metal salts of unsaturated carboxylic acids that contain about 3 to 8 carbons, such as acrylic acid or methacrylic acid, etc. In order to achieve a high resilience property, zinc salts of acrylic acids are preferable.

The preferable proportion of the metal salt of unsaturated carboxylic acid is, based on 100 parts by weight of basic rubber, generally about 20 to 50 parts by weight, and particularly about 25 to 45 parts by weight. If the proportion thereof falls into the above range, the resulting golf ball can attain a sufficient resilience property, accordingly achieving a sufficiently long flight distance as well as a sufficiently soft feel.

Examples of the filler include zinc oxide, barium sulfate, calcium carbonate, etc. The preferable proportion of the filler is, based on 100 parts by weight of basic rubber, generally about 10 to 30 parts by weight and particularly about 15 to 25 parts by weight. If the proportion thereof falls into the above range, the weight of the resulting golf ball becomes appropriate.

2) Intermediate Layer or Outer Core

As the materials for the intermediate layer and the outer core, known rubber compositions for use in an intermediate layer and an outer core of a multi-piece solid golf ball, respectively, can be used.

The kinds of materials that compose these rubber compositions are the same as the above-described materials used for the core. However, in order to give the intermediate layer a lower hardness than the core, the material for the intermediate layer can contain cross-linking agents and cocross-linking agents in a lesser proportion than the material for the core. In order to make the outer core have a lower hardness than the inner core, the material for the outer core contains cross-linking agents and cocross-linking agents in a lesser proportion than the material for the inner core.

Specifically, it is preferable that the rubber compositions as the materials for the intermediate layer or the outer core comprise the cross-linking agents in a proportion, based on 100 parts by weight of basic rubber, of generally about 0.5 to 2.5 parts by weight and particularly about 0.5 to 2.0 parts by weight. Furthermore, the preferable proportion of the cocross-linking agents is, based on 100 parts by weight of basic rubber, generally about 15 to 45 parts by weight and particularly about 20 to 40 parts by weight.

3) Each Step

In step i) of the method of the present invention, a pair of outer-layer-pieces that comprises the foresaid semi-vulcanized rubber compositions are simultaneously prepared. It is preferable that the semi-vulcanized condition be such that, when expressed as torque measured by a curastmeter, the torque becomes the sum of the torque immediately after the start of vulcanization and about 20 to 70% (particularly about 30 to 65%, and more particularly about 30 to 60%) of the difference between the torque immediately after the start of vulcanization and that after the completion of vulcanization.

In order to make the rubber composition into a semi-vulcanized condition, heretofore known vulcanization methods can be employed. Examples of such heretofore known vulcanization methods include vulcanizing press under applied heat in a mold (vulcanizing molding process), steam vulcanization, high-frequency vulcanization, radiation cure, electron beam closslinking, etc.

Particularly, press vulcanization is preferable. By heating and pressing the rubber composition generally at about 110 to 130° C., particularly at about 120 to 130° C., and more particularly at about 125 to 130° C., generally for about 4 to 20 minutes, particularly for about 5 to 10 minutes, and more particularly for about 5 to 7 minutes, outer-layer-pieces contains a semi-vulcanized rubber composition that has torque in the range described above can be obtained.

In step iii), rubber that is contained in the outer-layer-pieces is vulcanized. In terms of the vulcanization method, heretofore known vulcanization methods can be employed. Particularly, press vulcanization is preferable. The semi-vulcanized rubber composition can be vulcanized by applying pressure while heating, generally at about 140 to 165° C., particularly at about 140 to 155° C., and more particularly at about 145 to 155° C., generally for about 10 to 30 minutes, particularly for about 10 to 20 minutes, and more particularly for about 10 to 15 minutes.

Method of Mold Usage

In the method of the present invention, it is preferable that the outer layer be formed using the above-described mold of the present invention. In other words, it is preferable that a multi-piece golf ball be manufactured by the method described below.

A method for manufacturing a multi-piece golf ball that is composed of a core material and an outer layer molded on the surface of the core material, which comprises the steps of:

i) using a mold provided with upper and lower parts of the mold each having one, two or more semispherical concave portions, and a middle part of the mold arranged therebetween when necessary, wherein the middle part of the mold comprises semispherical convex portions having a radius smaller than that of the mold cavity formed by concave portions of the upper and lower parts of the mold, and a plate-like separator having a size that can cover the concave portions of the upper and lower parts of the mold, wherein the semispherical convex portions are disposed on both surfaces of the separator in positions corresponding to the concave portions of the upper and lower parts of the mold;

simultaneously molding a pair of semispherical outer-layer-pieces comprises a composition that contains semi-vulcanized rubber, by vulcanizing the rubber while pressing the rubber composition between the concave portions of the upper and lower parts of the mold and the corresponding convex portions of the middle part of the mold;

ii) removing the middle part of the mold while keeping the outer-layer-pieces attached to the corresponding upper and lower parts of the mold, inserting a separately molded core material between the outer-layer-pieces that are attached to the upper and lower parts of the mold, and bringing the end surfaces of the openings of the pair of outer-layer-pieces into contact; and

iii) pressing the outer-layer-pieces and the core material between the upper and lower parts of the mold, vulcanizing the rubber that is contained in the outer-layer-pieces, and thereby molding an outer layer that comprises a rubber composition on the surface of the core material.

In the above-described step i), the pair of outer-layer-pieces that contains a semi-vulcanized rubber composition can be formed by known vulcanization methods; however, vulcanizing press under applied heat in a mold (vulcanizing molding process) is preferable. The desirable heating temperature and period of time for heating are as described above. Also in step iii), known vulcanization methods can be employed; however, vulcanizing press under applied heat in a mold is preferable. The desirable heating temperatures and periods of time for heating are as described above.

Shape and Hardness of the Outer Layer

When an outer layer is formed using a mold that comprises an upper part and a lower part, each having a semispherical concave portion, the outer surface of the outer layer becomes spherical. When an outer layer is molded using a mold that comprises an upper part and a lower part, each having one, two or more small concave portions of the same height on the semispherical concave portion, the outer surface of the outer layer has a shape such that protrusions, ribs or the like are formed on the surface of the spherical body.

The thickness of the outer layer may be about 0.5 to 10 mm, when the outer layer is an intermediate layer, and about 0.5 to 10 mm, when the outer layer is the outer core.

when the outer layer is an intermediate layer, it may have a JIS-C hardness of about 45 to 65, and when the outer layer is the outer core, it may have JIS-C hardness of about 45 to 65. By suitably selecting the kinds of constituent materials, the proportions thereof, and the like in the above-described range, such hardness can be obtained. By adjusting the hardness to fall into this range, it is possible to achieve a sufficiently long flight distance and soft feel.

4) Post Process

In the method of the present invention, after molding the outer layer, by simply molding a cover or an additional outer layer and a cover by a known method and subjecting it to polishing, painting, printing, etc., a multi-piece golf ball can be obtained.

### DETAILED DESCRIPTION OF THE PREFERRED EMBODIMENTS

Next, the mold of the present invention and the method of the present invention will be explained below by referring to the drawings.

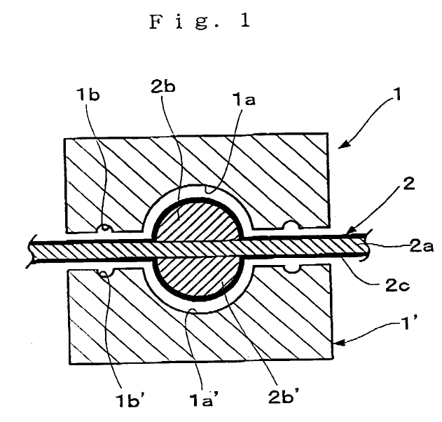

FIG. 1 is a cross-sectional view schematically showing one example of the mold of the present invention. This mold comprises an upper part of the mold 1, a lower part of the mold 1′, and a middle part of the mold 2 that is arranged between the upper part of the mold 1 and the lower part of the mold 1′, when necessary. On the surfaces that join the middle part of the mold, the upper part of the mold 1 and the lower part of the mold 1′ respectively have semispherical concave portions 1a, 1a′ and ring-shaped concave portions 1b, 1b′, which are located on the outer sides of the semispherical concave portions 1a, 1a′ and have semicircular profiles in their vertical cross-sections. Here, the radius of the semispherical concave portions 1a, 1a′ is 19.4 mm.

Furthermore, the middle part of the mold 2 comprises a plate-like separator 2a having a size that can cover the concave portions 1a, 1a′ of the upper part of the mold 1 and the lower part of the mold 1′, and semispherical convex portions 2b, 2b′ on predetermined positions of both surfaces of the separator 2a. Here, the radius of the semispherical convex portions 2b, 2b′ is 17.4 mm. The surface portion of the middle part of the mold comprising the separator 2a and the convex portions 2b, 2b′ is formed of a mold-releasing layer 2c.

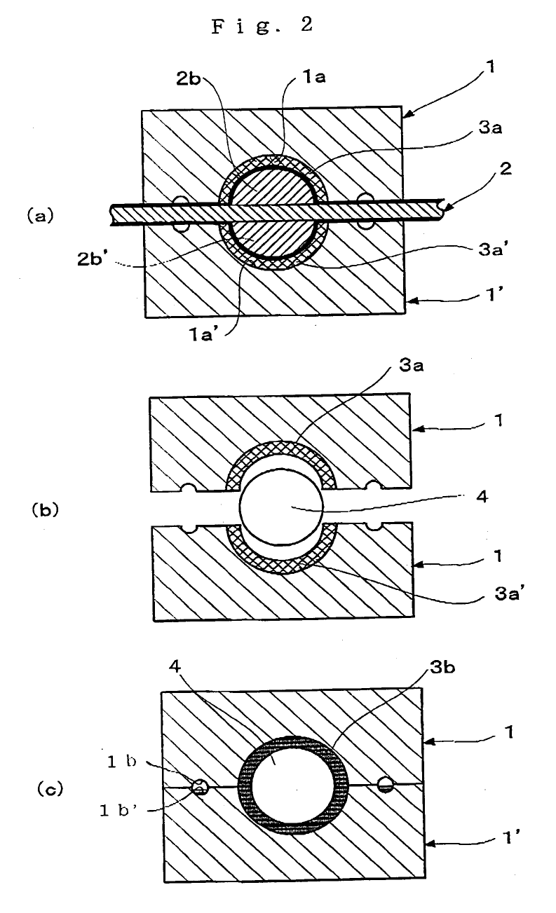

To form an intermediate layer that contains a rubber composition on the surface of the core of a three-piece golf ball using this mold and following one example of the present invention, as shown in FIG. 2(a), an unvulcanized rubber composition is first placed between the concave portions 1a, 1a′ of the upper part of the mold 1 and the lower part of the mold 1′ and the convex portions 2b, 2b′ of the middle part of the mold 2, and then the mold is closed. Thereafter, by heating the mold containing the unvulcanized rubber composition, a pair of semi-vulcanized semispherical intermediate layer pieces 3a, 3a′ are simultaneously molded. The heating temperature can be generally about 110 to 130° C., particularly about 120 to 130° C., and more preferably about 125 to 130° C., and the heating period of time is generally about 4 to 20 minutes, particularly about 5 to 10 minutes, and more particularly about 5 to 7 minutes.

Then, as shown in FIG. 2(b), while keeping the semi-vulcanized intermediate layer pieces 3a, 3a′ attached to the upper part of the mold 1 and the lower part of the mold 1′ respectively, the upper part of the mold 1 and the lower part of the mold 1′ are opened and the middle part of the mold 2 is removed. After that, a separately obtained core 4 is inserted between the intermediate layer pieces 3a, 3a′ that are attached to the upper part of the mold 1 and the lower part of the mold 1′, respectively. Then, as shown in FIG. 2(c), the upper part of the mold 1 and the lower part of the mold 1′ are closed in such a manner that the peripheral portions ,i.e. end faces, of the openings of the intermediate layer pieces 3a, 3a′ contact each other. At this time, if there is an excess of intermediate layer piece material, the excessive material will be held in the secondary concave portions 1b, 1b′ of the upper part of the mold 1 and the lower part of the mold 1′ that serve as a flash groove.

Then, by heating the mold containing the intermediate layer pieces 3a, 3a′, the intermediate layer pieces 3a, 3a′ are fully vulcanized. The heating temperature may be generally about 140 to 165° C. and particularly about 140 to 155° C. The period of time for heating may be generally about 10 to 30 minutes and particularly about 10 to 20 minutes. Thereby, an intermediate product for a three-piece golf ball in which an intermediate layer 3b is formed on the surface of the core 4 can be obtained.

Thereafter, a cover is molded by injection molding or like known methods, and the result is painted, printed, etc., to produce a three-piece golf ball.

### EXAMPLE

The present invention will be explained below by referring to Examples and Test Examples; however, the scope of the present invention is not limited to these Examples.

### Manufacturing of Core (Reference Example)

By using a rubber composition containing 100 parts by weight of butadiene rubber (BR-11, manufactured by JSR Corporation), 25 parts by weight of zinc acrylate, 20 parts by weight of zinc oxide, 2 parts by weight of dicumyl peroxide, and 0.5 part by weight of antioxidant, a spherical core having a radius of 17.4 mm was manufactured.

### Example 1

An unvulcanized rubber composition containing 100 parts by weight of unvulcanized butadiene rubber (BR-11, manufactured by JSR Corporation), 20 parts by weight of zinc acrylate, 20 parts by weight of zinc oxide, 1.8 parts by weight of dicumyl peroxide, and 0.5 part by weight of antioxidant was prepared.

The resulting unvulcanized rubber composition was made into semi-vulcanized state by placing it between the concave portion 1a of the upper part of the mold 1 and the convex portion 2a of the middle part of the mold 2, and between the concave portion 1a′ of the lower part of the mold 1′ and the convex portion 2b′ of the middle part of the mold 2 as shown in FIG. 1, followed by heating at 130° C. for 6 minutes.

Then, the upper and lower parts of the mold 1, 1′ were opened, the middle part of the mold 2 was removed, the core obtained in the Reference Example was inserted between the upper and lower parts of the mold 1, 1′, and the upper and lower parts of the mold 1, 1′ were closed. Thereafter, the butadiene rubber was integrally vulcanized by heating at 150° C. for 20 minutes, obtaining an intermediate layer having a thickness of 2 mm. Thereby, an intermediate product for a three-piece golf ball was obtained.

Then, on the outer side of the intermediate layer, a 2-mm-thick cover that was made of an ionomer resin containing HIMILAN 1706 (manufactured by Mitsui-DuPont Polychemicals Co., Ltd.) and HIMILAN 1605 (manufactured by Mitsui-DuPont Polychemicals Co., Ltd.) in a weight ratio of 1:1 was molded by injection molding.

### Comparative Example 1

The same mold as shown in FIG. 1 was used, except that the mold used in this example has a pair of molds each provided on one surface with a convex portion having the same size as that of the middle part of the mold shown in FIG. 1, instead of the middle part of the mold having convex portions on both surfaces, and a semi-vulcanized semispherical intermediate layer and a fully vulcanized semispherical intermediate layer were separately molded. To be more specific, the same procedure as in Example 1 was conducted except that the unvalcanized rubber composition was converted to fully vulcanized state by heating at 150° C. for 15 minutes instead of the unvulcanized rubber composition was converted into semi-vulcanized state, and thereby one semispherical intermediate layer was obtained. Furthermore, by following the same procedure as in Example 1, the other semispherical intermediate layer, which was in a semi-vulcanized state, was obtained by heating at 130° C. for 6 minutes.

Then, the upper and lower parts of the mold were opened, the pair of middle parts of the mold wasremoved, the core that was obtained in the Reference Example was inserted between the upper part and lower part of the mold, and the semi-vulcanized semispherical intermediate layer was converted into fully vulcanized state by heating at 150° C. for 20 minutes, thereby an intermediate layer having a thickness of 2 mm was formed on the outer surface of the core.

Then, by following the same procedure as in Example 1, a cover having a thickness of 2 mm was formed.

### Comparative Example 2

On the outer surface of the core that was molded in the Reference Example, a 2-mm-thick intermediate layer made of Hytrel 4767 (manufactured by Du Pont-Toray Co., Ltd., polyester based thermoplastic elastomer) was formed by injection molding.

Thereafter, by following the same procedure as in Example 1, a cover having a thickness of 2 mm was molded.

Putter Test Twenty golf balls obtained by each of Example 1 and Comparative Examples 1 and 2 were rolled on a plane surface for 15 m using a putting robot equipped with a pendulum arm, and the standard deviation of the lateral distance of each set of 20 balls was calculated.

The standard deviation of the lateral swing distance of the balls obtained in Example 1 was 11.3 cm, that of the balls obtained in Comparative Example 1 was 21.1 cm, and that of the balls obtained in Comparative Example 2 was 20.2 cm. It is clear that the golf balls in which the intermediate layers were formed according to the method of the present invention exhibit little eccentricity in the intermediate layers.

Durability Test

With a driver (wood #1), 300 golf balls obtained by each of Example 1 and Comparative Examples 1 and 2 were hit one by one at a head speed of 43 m/sec. When the number of balls broken by being hit reached 30, the total number of balls hit was determined, and this number was defined as the ball's durability index. The greater the durability index, the better the durability.

Setting the durability index of the balls obtained in Example 1 to 100, the durability index of the balls obtained in Comparative Example 1 was 85, and that of Comparative Example 2 was 98. It is clear that the golf balls having the intermediate layers formed according to the method of the present invention exhibit greater strength than those of Comparative Example 1 in which the intermediate layers were obtained by attaching the completely vulcanized semispherical intermediate layers each other.

1. A mold for forming an outer layer of a multi-piece golf ball comprising upper and lower parts of the mold each having one, two or more semispherical concave portions, and a middle part of the mold arranged therebetween when necessary,
the middle part of the mold comprising semispherical convex portions having a radius smaller than that of the mold cavity formed by concave portions of the upper and lower parts of the mold, and a plate-like separator having a size that can cover the concave portions of the upper and lower parts of the mold,
the semispherical convex portions being disposed, on both surfaces of the separator in positions corresponding to the concave portions of the upper and lower parts of the mold.

2. The mold for forming an outer layer of a multi-piece golf ball according to claim 1, wherein the upper and lower parts of the mold comprise one, two or more small concave portions of the same depth on the surfaces of the semispherical concave portions.

3. The mold for forming an outer layer of a multi-piece golf ball according to claim 1, wherein the surfaces of the concave portions of the upper and lower parts of the mold have a greater mold-releasing resistance than the surface of the middle part of the mold.

4. A method for manufacturing a multi-piece golf ball that is provided with a core material and an outer layer formed on the surface of the core material, the method comprising :
i) simultaneously forming a pair of semispherical outer-layer-pieces comprising a composition that contains semi-vulcanized rubber;
ii) inserting a separately formed core material between the pair of outer-layer-pieces, and bringing the end faces of the openings of the pair of outer-layer-pieces into contact; and
iii) forming an outer layer comprises a rubber composition on the surface of the core material by vulcanizing the rubber contained in the outer-layer-pieces.

5. The method according to claim 4, wherein the condition of the semi-vulcanized rubber, when expressed as torque measured by a curastmeter, is such that the torque becomes the sum of the torque immediately after the start of vulcanization and 20 to 70% of the difference between the torque immediately after the start of vulcanization and that after the completion of vulcanization.

6. The method according to claim 4, wherein the outer layer serves as the intermediate layer of a three-piece golf ball and the core material serves as the core of the three-piece golf ball.

7. The method according to claim 4, wherein the outer layer becomes the outer core layer of a three-piece golf ball and the core material becomes the inner core of the three-piece golf ball.

8. A method for manufacturing a multi-piece golf ball that is provided with a core material and an outer layer formed on the surface of the core material, the method comprising :
i) using a mold provided with upper and lower parts of the mold each having one, two or more semispherical concave portions, and a middle part of the mold arranged therebetween when necessary, wherein the middle part of the mold comprises semispherical convex portions having a radius smaller than that of the mold cavity formed by concave portions of the upper and lower parts of the mold, and a plate-like separator having a size that can cover the concave portions of the upper and lower parts of the mold, wherein the semispherical convex portions are disposed on both surfaces of the separator in positions corresponding to the concave portions of the upper and lower parts of the mold;
simultaneously forming a pair of semispherical outer-layer-pieces comprising a composition that contains semi-vulcanized rubber, by vulcanizing the rubber while pressing the rubber composition between the concave portions of the upper and lower parts of the mold and the corresponding convex portions of the middle part of the mold;
ii) removing the middle part of the mold while keeping the outer-layer-pieces attached to the corresponding upper and lower parts of the mold, inserting a separately formed core material between the outer-layer-pieces that are attached to the upper and lower parts of the mold, and bringing the end faces of the openings of the pair of outer-layer-pieces into contact; and
iii) pressing the outer-layer-pieces and the core material between the upper and lower parts of the mold, vulcanizing the rubber that is contained in the outer-layer-pieces, and thereby forming an outer layer that comprises a rubber composition on the surface of the core material.

9. The method according to claim 8, wherein the upper and lower parts of the mold have one, two or more small concave portions of the same depth on the surfaces of the semispherical concave portions thereof.

10. The method according to claim 8, wherein the surfaces of the concave portions of the upper and lower parts of the mold have a greater mold-releasing resistance than the surface of the middle part of the mold.

11. The method according to claim 8, wherein the condition of the semi-vulcanized rubber, when expressed as torque measured by a curastmeter, is such that the torque becomes the sum of the torque immediately after the start of vulcanization and 20 to 70% of the difference between the torque immediately after the start of vulcanization and that after the completion of vulcanization.

12. The method according to claim 8, wherein the outer layer serves as the intermediate layer of a three-piece golf ball and the core material serves as the core of the three-piece golf ball.

13. The method according to claim 8, wherein the outer layer serves as the outer core layer of a three-piece golf ball and the core material serves as the inner core of the three-piece golf ball.
